(19) United States
(12) Patent Application Publication
(10) Pub. No.: US 2022/0082684 A1
(43) Pub. Date: Mar. 17, 2022

(54) MILLIMETER WAVE RADAR GESTURE RECOGNITION METHOD AND DEVICE BASED ON TRAJECTORY JUDGMENT

(71) Applicant: Hangzhou Innovation Research Institute of Beijing University of Aeronautics and Astronautics, Hangzhou (CN)

(72) Inventors: Yuxi Han, Hangzhou (CN); Shu Li, Hangzhou (CN); Jingtao Zhang, Hangzhou (CN); Jun Wang, Hangzhou (CN)

(21) Appl. No.: 17/535,973

(22) Filed: Nov. 26, 2021

(30) Foreign Application Priority Data
Sep. 7, 2021 (CN) 202111042676.3

(51) Int. Cl. G01S 13/62; G01S 13/89; G06F 3/01; G06V 40/20

(52) U.S. Cl. CPC G01S 13/62; G06V 40/20; G06F 3/017; G01S 13/89

(57) ABSTRACT

A millimeter wave radar gesture recognition method and device based on trajectory judgment are provided. The method includes steps as follows: Step 1, obtaining data information of each point of a hand trajectory according to echo signals. Step 2, setting a retrieval method of trajectory start point and end point, do not miss any gestures while reducing repeated trajectory judgments. Step 3, for a trajectory with given start point and end point, calculating slopes of least squares straight lines of Y coordinates and Z coordinates with respect to t coordinates which represent time respectively, then precluding impossible basic gestures and judging whether current gesture is one of remaining basic gestures. Step 4, if continuously determined basic gestures constitute a combined gesture, outputting the combined gesture determination result.

### CROSS REFERENCE OF RELATED APPLICATION

The present invention claims priority under 35 U.S.C. 119(a-d) to CN 202111042676.3, filed Sep. 7, 2021.

### TECHNICAL FIELD

The present invention belongs to the technical field of millimeter wave radar systems. In particular, it relates to a millimeter wave radar gesture recognition method and device based on trajectory judgment.

### BACKGROUND

Dynamic gesture is one of the most understandable and simple ways of human-computer interaction. At present, gesture recognition has been applied in wearable mobile devices, gesture controlled smart TV, gesture controlled smart home, automatic entertainment systems, AR/VR (augmented reality/virtual reality) and other scenes. Sensors used in gesture recognition systems mainly include camera-based sensors, depth-based sensors and embedded gloves with 3D tracking technology. However, these systems have large bottlenecks which will limit their applications. Camera-based sensors are easily affected by light, color and background with large computational overhead due to large-scale image processing. Depth-based sensors are easier to detect position changes, but cannot detect directions or specific hand shapes. Wearable technologies will interfere with other tasks in daily life of users and limit system inputs to people wearing input devices.

A millimeter wave radar sensor is not affected by light. It can accurately detect specific movement directions and trajectories of hands. Its chip size can be less than 1 cm², and transmitted wireless signals can penetrate some materials. Therefore, it is easy to hide behind the equipment panel which provides more possibilities for equipment appearance design. In addition, millimeter wave radars have the advantages of low cost, low power consumption and low computational complexity. It does not collect any image, sound or other information, which essentially avoids the risk of user privacy disclosure.

However, conventional millimeter wave radar gesture interaction systems need to collect a large number of data sets of specific gestures for training, which has few functions and poor scalability. Therefore, designing a millimeter wave radar gesture recognition device with high accuracy, comprehensive functions and strong scalability is of great significance to commercial applications of millimeter wave radars.

### SUMMARY OF THE PRESENT INVENTION

The present invention aims to solve the problems of conventional millimeter wave radar gesture recognition systems such as incomplete functions, poor scalability and high operation overhead. In order to overcome the shortcomings of the prior art, a millimeter wave radar gesture recognition method and device based on trajectory judgment are proposed. Gestures which can be accurately judged include basic gestures such as left swing, right swing, up swing and down swing. Besides, a combined gesture based on the above basic gestures can also be judged.

The present invention proposes a millimeter wave radar gesture recognition method and device based on trajectory judgment. The device comprises a millimeter wave RF (Radio Frequency) transceiver unit, a micro control unit, a transmitting antenna and a receiving antenna.

The micro control unit is connected to the millimeter wave RF transceiver unit. The millimeter wave RF transceiver unit is connected to the transmitting antenna and the receiving antenna respectively. The millimeter wave RF transceiver unit generates corresponding millimeter wave radar signals according to radar waveform parameters, receives echo signals reflected by the millimeter wave radar signals by human hands, and then transmits the echo signals to the micro control unit. The micro control unit can use a mature commercial micro control unit, such as a single chip microcomputer which can run a gesture recognition program after the program is burning to it. Besides, the micro control unit can output judgment results of personnel gestures by processing the echo signals. The transmitting antenna transmits the millimeter wave radar signals generated by the millimeter wave RF transceiver unit. The receiving antenna receives the millimeter wave radar signals reflected from space and transmits die millimeter wave radar signals reflected from space to the millimeter wave RF transceiver unit.

A radar board is Y-Z plane. Perpendicular to the radar is X-axis, and the front of the board is the positive direction of the X-axis. Y-axis is parallel to the ground. When a person is facing the radar, the left hand is in the negative direction of the Y-axis and the right hand is in the positive direction of the Y-axis. Z axis is perpendicular to the ground. Upward is the negative direction of the Z axis and downward is the positive direction of the Z axis.

A millimeter wave radar gesture recognition method based on trajectory judgment is mainly completed during a process of dealing with echo signals by the micro control unit, which specifically includes steps as follows:

Step 1: obtaining data information of each point of a human hand movement trajectory by the micro control unit according to echo signals.

Step 2: setting a retrieval method of a start point and an end point of a trajectory, which obeys rules of including all gestures while reducing repeated trajectory judgments.

Step 3: for a trajectory whose start point and end point are given, first calculating slopes of least squares straight lines of Y coordinates and Z coordinates with respect to t coordinates which represent time respectively; precluding impossible basic gestures, then judging whether a current gesture is one of remaining basic gestures combining with a variation amplitude of each coordinate axis direction, wherein the basic gestures refer to left swing, right swing, up swing and down swing.

Step 4: if continuously determined basic gestures constitute a combined gesture, outputting a combined gesture determination result.

Furthermore, specific contents described in the Step 1 are as follows:

Each point of a human hand motion trajectory specifically includes information as follows:
(1) a frame number which is denoted by frame_num,
(2) a number of points collected by a millimeter wave radar in a current frame which is denoted by target_num,
(3) a current time value which is denoted by msec, and
(4) a 3D coordinate of a currently collected point which is denoted by (x,y,z).

Furthermore, specific contents described in the Step 2 are as follows:

S201, a state variable curState is introduced to represent a gesture judgment result of a current trajectory. Its initial value can be set as “RANDOM”. Both a initial start point and an end point are set as the first point of millimeter wave radar data acquisition. When a point of the next time arrives, the start point remains unchanged and the end point becomes the point of the current time. At the same time, denote the minimum time interval by minGPartInterval. When the time interval between the start point and the end point of the current trajectory is less than minGPartInterval, a gesture recognition algorithm does not judge the current trajectory. In other words, the gesture recognition algorithm requires that a time interval of a single gesture is not less than minGPartInterval. When a new point arrives, the end point is updated to the point of the current time. If the time interval between the start point and the end point is not less than minGPartInterval, a specific gesture judgment starts up.

S202, when the time interval between the start point and the end point of the current trajectory is greater than or equal to minGPartInterval, judge which basic gesture the trajectory belongs to. The results can be classified into five categories, namely, left swing, right swing, up swing, down swing and random. Then, the value of curState is updated to the corresponding state.

If the result is left swing, the value of curState switches to “LEFT”. The start point remains unchanged, and the end point is the last point of the current time. If the left swing is interrupted, the start point and the end point of the left swing are output. Considering that points collected by the millimeter wave radar are gradually obtained over time, in order to ensure real-time performance, the new start point and end point are set as the end point at the end of the left swing. When the point of the next time arrives, the start point remains unchanged, and the end point becomes the point of this time. Right swing, up swing, down swing and left swing obey the similar rules.

If the result is random or exceeds the maximum time interval maxGPartInterval and the basic gesture has not been judged out, the start point moves forward one point and the end point remains unchanged until the time interval between the start point and the end point is less than minGPartInterval. At this time, the end point can slide back one point, and the start point becomes the end point at the end of the previous basic gesture.

Parameters defined above such as minGPartInterval and maxGPartInterval can be determined through a large number of gesture waving data considering given gesture recognition accuracy requirements. Considering human habits, a value range of minGPartinterval is usually 0.3 s-1 s, and a value range of maxGPartinterval is 1.5 s-4 s. Those skilled in the art can also fine tune according to specific application scenarios and actual performance requirements.

S203, in order to improve gesture recognition algorithm efficiency, repeated judgment times of a trajectory should be reduced. Therefore, before a new point arrives, gesture judgements for trajectories ending at current last point should have been finished. This ensures that when a new point arrives, only the trajectory ending at this point will be judged.

Furthermore, specific contents described in the Step 3 are as follows:

A self-defined outer function gStartEndInner is introduced to update the start point and end point of a trajectory for gesture judgment.

S301, for a trajectory with given start point and end point, calculating slopes of least squares straight lines of Y coordinates and Z coordinates YT and ZT with respect to t coordinates which represent time respectively, wherein YT and ZT reflect average velocities of the trajectory in Y-axis and Z-axis directions respectively.

S302, denote a change amplitude of X coordinates of points on the trajectory by dx, in the present invention, dx is calculated by subtracting a minimum value from a maximum value, in remaining X coordinates after removing maximum and minimum X coordinates, dv and dz are calculated in the similar way.

S303, when the value of curState in current time is “RANDOM”.
(a) if |YT|>|ZT|, YT<0, only judging whether the current trajectory is the left swing;
(b) if |YT|>|ZT|, YT>0, only judging whether the current trajectory is the right swing;
(c) if |YT|<|ZT|, YT<0, only judging whether the current trajectory is the up swing;
(d) if |YT|<|ZT|, YT>0, only judging whether the current trajectory is the down swing; and

S304 When the value of curState in current time is not “RANDOM”:
(a) if curState==“LEFT”, only judging whether the current left swing is interrupted;
(b) if curState==“RIGHT”, only judging whether the current right swing is interrupted;
(c) if curState==“UP”, only judging whether the current up swing is interrupted; and
(d) if curState==“DOWN”, only judging whether the current down swing is interrupted.

Take left swing for example, judging whether a trajectory with given start point and end point is left swing can be discussed in two cases:

Case 1: the value of curState is “RANDOM”

for the left swing, the Y coordinates conform to a decreasing trend; for two points collected at adjacent times on the trajectory, if the Y coordinate of current time point is greater than that of previous time point, the current time point is considered as a defect point; if |YT|>|ZT|, YT<0 and all the following conditions are met, the value of curState is switched to “LEFT”. Condition a, defect points should be less than a preset maximum number while a percentage of the defect points should be less than a preset maximum percentage; a value range of maximum defect points is 3-7 and a value range of maximum percentage of the defect points is 20%-35%; Condition b, Y coordinates of second and third points on the trajectory are less than the Y coordinate of the start point; Condition c, a number of points the trajectory contains at least is denoted by minNum whose value range is 3-7; Condition d, dy>dz; Condition e, both dx and dz do not exceed a specified threshold which is set as an average upper limit distance of waving gestures of testers; and Condition f, a minimum distance which is set for each basic gesture is denoted by minDistance; a gesture swing amplitude recognized by the method of the present invention is not less than a minimum distance whose value range is 0.10 m-0.20 m.

Case 2: the value of curState is “LEFT”

when one of the following conditions is met, the left swing is interrupted: Condition a, Y coordinates of two consecutive points increase; Condition b, increase amplitudes of Z coordinates of two consecutive points are greater than decrease amplitudes of Y coordinates; Condition c, decrease amplitudes of Z coordinates of two consecutive points are greater than the decrease amplitudes of the Y coordinates; Condition d, a number of defect points exceeds a preset maximum number while a percentage of the defect points exceeds a preset maximum percentage; a value range of maximum defect points is 3-7 and a value range of a maximum percentage of the defect points is 20%-35%; and Condition e, dx or dz exceeds a specified threshold which is as an average upper limit distance of waving gestures of testers; when the left swing is interrupted, the start point of the current trajectory become the start point of the left swing, and the end point becomes a point at the previous time of the interruption point; the value of curState is switched to “RANDOM”.

Similarly, formation and interruption of right swing, up swing and down swing can be judged.

Furthermore, specific contents described in the Step 4 are as follows:

Several combined gestures are pre-defined in the present invention, such as drawing a rectangle clockwise, which is composed of four basic gestures, namely, right swing, down swing, left swing and up swing. At the same time, a structure array is defined in the gesture recognition algorithm to cache the judgment results of the basic gestures. When there are four successive basic gestures of the right swing, the down swing, the left swing and the up swing, a pre-defined combined gesture can be output. On the other hand, considering that the gesture will be interrupted due to external interference in the waving process, and determination of a combined gesture requires that all the basic gestures are determined successfully, the present invention combines two consecutive and identical basic gestures into one in the determination process of the combined gesture.

A millimeter wave radar gesture recognition method and device based on trajectory judgment have the advantages and effects as follows: a millimeter wave radar sensor is not affected by light, can accurately detect specific movement directions and trajectories of hands. It has low cost, low power consumption, low computational complexity and perfect user privacy protection. The gesture recognition method based on trajectory judgment makes full use of statistical characteristics and does not need to collect a large number of data sets of specific gestures for training. It has comprehensive functions, strong scalability, and high recognition accuracy.

### BRIEF DESCRIPTION OF THE DRAWINGS

FIG. 1 is a basic block diagram of various components of a millimeter wave radar gesture recognition device;

FIG. 2 is an example diagram of a micro control unit using a single chip microcomputer; and

FIG. 3 is a basic block diagram of a gesture recognition algorithm.

### DETAILED DESCRIPTION OF THE PREFERRED EMBODIMENT

In order to make the purpose, technical scheme and advantages of the embodiment of the present invention clearer, the embodiments of the present invention will be described in detail below in combination with accompanying drawings. However, it can be understood by those skilled in the art that many technical details have been proposed in various embodiments of the present invention in order to make readers better understand the present invention. Furthermore, even without these technical details and various changes and modifications based on the following embodiments, the technical scheme claimed by the present invention can be realized.

The present invention proposes a millimeter wave radar gesture recognition device based on trajectory judgment. A radar board is Y-Z plane. Perpendicular to the radar is X-axis, and the front of the board is the positive direction of the X-axis. Y-axis is parallel to the ground. When a person is facing the radar, the left hand is in the negative direction of the Y-axis and the right hand is in the positive direction of the Y-axis. Z axis is perpendicular to the ground. Upward is the negative direction of the Z axis and downward is the positive direction of the Z axis.

The device is mainly composed of a millimeter wave RF transceiver unit, a micro control unit, a transmitting antenna and a receiving antenna. Its system framework is shown in FIG. 1.

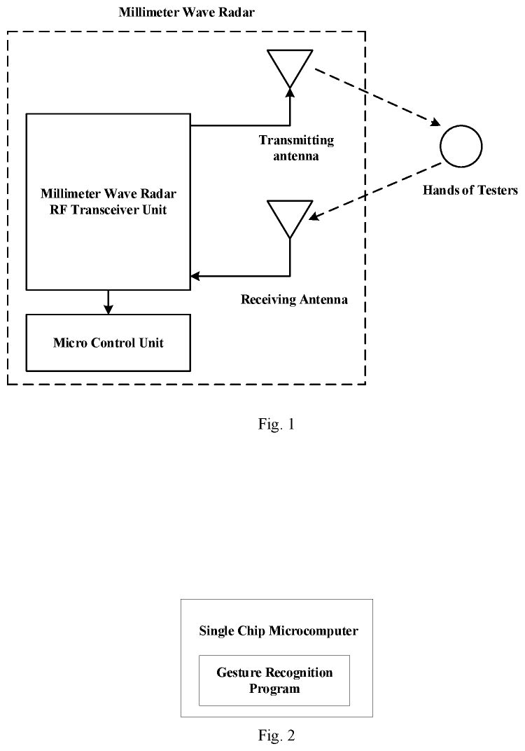

The millimeter wave RF transceiver unit generates corresponding millimeter wave radar signals according to radar waveform parameters, receives echo signals reflected by the millimeter wave radar signals by human hands, and then transmits the echo signals to the micro control unit. A mature commercial micro control unit, such as a single chip microcomputer which can run a gesture recognition program after the program is burning to the micro control unit (as shown in FIG. 2) can be used as the micro control unit. It can also process the echo signals to obtain judgment results of gestures. The transmitting antenna is used to transmit the millimeter wave radar signals generated by the millimeter wave RF transceiver unit. The receiving antenna is used to receive the millimeter wave radar signals reflected from space and transmit the millimeter wave radar signals reflected from space to the millimeter wave RF transceiver unit.

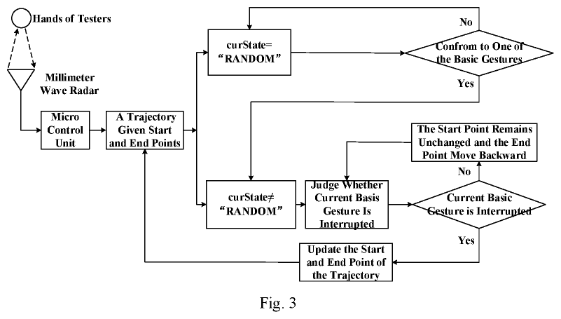

According to the present invention, a millimeter wave radar gesture recognition method based on trajectory judgment, is a statistical method. It is mainly completed during a process of dealing with echo signals by the micro control unit. The main process is shown in FIG. 3, which includes steps as follows:

Step 1: obtaining data information of each point of a human hand movement trajectory by the micro control unit according to echo signals.

The data information is saved in a structure array trajArray which is comprised of elements as follows:
(1) a frame number which is denoted by frame_num,
(2) a number of points collected by millimeter wave radar in a current frame which is denoted by target_num,
(3) a current time value which is denoted by msec, and
(4) a 3D coordinate of currently collected point which is denoted by (x,y,z).

Step 2: in the gesture recognition method based on the trajectory judgment, at first defining a retrieval method of a trajectory with given start point and end point for gesture judgments.

This method should follow a principle of not missing any gestures and reducing repeated trajectory judgments as much as possible. In order to improve gesture recognition efficiency, before a new point arrives, gesture judgements for trajectories ending at current last point should have been finished. This ensures that when a new point arrives, only trajectories ending at current last point will be judged.

In the present invention, an outer function gStartEndInner is defined to update the start point and the end point of the trajectory for the gesture judgment. The current gesture judgment state is denoted by curState. Input parameters of the gStartEndInner function include:
(1) trajArray, a structure array which contains all information of each point on the trajectory,
(2) trajTimeArray, a time array of each point on the trajectory,
(3) inStartIdx, a start point for trajectory retrieval, and
(4) inEndIdx, an end point for trajectory retrieval.

This function returns the start point and the end point of each basic gesture which is judged out. The basic gestures include left swing, right swing, up swing and down swing.

The gStartEndInner function calls a gStateTrans function to determine results of hand gestures for a trajectory whose start point and end point are given. Input parameters of the gStateTrans function include:
(1) curState,
(2) trajArray,
(3) trajTimeArray,
(4) trajStartIdx, a start point of the trajectory used for gesture judgments, its initial value is equal to inStartIdx, and
(5) inEndIdx.

This function returns gesture judgment results of a trajectory whose start point and end point are given.

Each run of the gStartEndInner function corresponds to a different inEndIdx. Under the same gStartEndInner function, the end point of each run of the gStateTrans function is fixed as inEndIdx, and the start point trajStartIdx is updated each time the gStateTrans function is run.

Under the gStartEndInner function, there are four static variables:
(1) round, times the gStartEndInner function is currently running;
(2) completeIdx, which can be used to record a previous point before an interrupted point of last basic gesture, its initial value can be set to 0;
(3) lastRoundState, the value of curState when the gStartEndInner function is run last time; and
(4) lastRoundEndIdx, the end point of the trajectory for gesture judgements last time the gStartEndInner function is run.

```
if round==1
  curState = “RANDOM”;
else
  curState = lastRoundState;
end
if round==1
inStartIdx==1;
end
if round>1
inStartIdx=completeIdx+1;
end
```

Running the gStateTrans function:

(1) if curState is changed from “RANDOM” to one of the basic gestures, record the start point trajStartIdx and current end point of the corresponding basic gesture, then completeIdx will be updated; the start point trajStartIdx remains unchanged and the end point slides backward (that is, the current gStartEndInner function ends and the next gStartEndinner function starts);
(2) if curState is changed from one of the basic gestures to “RANDOM”, the current basic gesture is interrupted; then completeIdx will be updated and the current gStartEndInner ends; both the start point and end point of the next running gStartEndInner function become the end point of the previous basic gesture; and
(3) if the gStateTrans function run twice in a row and both times values of curState are determined as “RANDOM” or the basic gesture is not determined after the maximum time interval maxGPartInterval, completeIdx will be updated; the start point trajStartIdx moves forward by one point; the end point remains unchanged; when the time interval between the start point and the end point is less than minGPartInterval, the end point can slide backward by one point (that is, after the current gStartEndInner function ends, the next gStartEndinner function start) and the start point of trajectory judgement becomes the end point at the end of the previous basic gesture; considering human habits, a value range of minGPartinterval is usually 0.3 s-1 s and a value range of maxGPartinterval is usually 1.5 s-4 s.

Before the end of each gStartEndInner function,

lastRoundState=curState;
lastRoundEndIdx=inEndIdx;
round=round+1;

Step 3: the gStateTrans function calls isGLeft, isGRight, isGUp and isGDown functions to judge the four basic gestures of left swing, right swing, up swing and down swing respectively.

On the other hand, if each of the above four functions is run once for a trajectory whose start point and end point are given, gesture recognition algorithm efficiency will be reduced. For a given trajectory, slopes of least squares straight lines of Y coordinates and Z coordinates with respect to t coordinates which represent time respectively can be calculated at first. Then impossible basic gestures can be eliminated to reduce gesture judgement range.

S301, calculating the slopes of the least squares straight lines of the Y coordinates and the Z coordinates of the points on the trajectory with respect to the t coordinates YT and ZT;

S302, when the current value of curState is “RANDOM”,

if |YT|>|ZT|, YT<0
running the isGLeft function;
end
if |YT|>|ZT|, YT>0
running the isGRight function;
end
if |YT|>|ZT|, YT>0
running the isGUp function;
end
if |YT|>|ZT|, YT>0
running the isGDown function;
end
S303,
if cur State==“LEFT”
running the isGLeft function;
if current gesture is not interrupted, curState remains “LEFT”;
if current gesture is interrupted, curState is switched to “RANDOM”;
end
if curState==“RIGHT”
running the isGRight function;
if current gesture is not interrupted, curState remains “RIGHT”;
if current gesture is interrupted, curState is switched to “RANDOM”;
end
if curState==“UP”
running the isGUp function;
if current gesture is not interrupted, curState remains “UP”;
if current gesture is interrupted, curState is switched to “RANDOM”;
end
if curState==“DOWN”
running the isGDown function;
if current gesture is not interrupted, curState remains “DOWN”;
if current gesture is interrupted, curState is switched to “RANDOM”;
end and

S304, after excluding impossible basic gestures, the gesture recognition algorithm only needs to judge whether the current gesture is the remaining basic gestures.

When running the gStateTrans function, the change amplitude of point coordinates on the trajectory which is denoted by dx should also be calculated. In the present invention, dx is defined by subtracting a minimum value from a maximum value in remaining coordinates after removing maximum and minimum X coordinates. Besides, dy and dz can be calculated in the similar way.

The isGLeft function includes steps as follows:

(1) for two points at adjacent times on a trajectory, if the Y coordinate in current time is greater than the Y coordinate in previous time, the point of the current time is defined as a defect point; at first, a number and a percentage of defect points on the trajectory are calculated;
(2) if curState==“RANDOM”
besides |YT|>|ZT|, YT<0, when all the following conditions are met, curState is switched to “LEFT”:
(a) the number and percentage of defect points is less than a preset number or percentage; these parameters can be set and adjusted through a large number of experimental data and on a premise of ensuring that gesture recognition accuracy reaches more than 90%; generally, a value range of the maximum number of defect points is 3-7 and a value range of the maximum defect point percentage is 20%-35%;
(b) the Y coordinates of second point and third point on the trajectory are less than the Y coordinates of the start point;
(c) the least number of points included in a trajectory is denoted by minNum, which is set through feature requirements and experimental data; in order to prevent slight gesture shaking in gesture recognition from being recognized, gesture recognition sensitivity cannot be too strong and minNum cannot be too small; besides, there cannot be too many difficulties of testers making specified gestures; therefore, it can be set to 3-7 through hundreds of groups of experimental data; a specific value can be finally determined in combination with performance requirements under a specific application scenario, but it cannot be less than 3;
(d) dy>dz;
(e) both dx and dz cannot exceed a specified threshold which can be set as an average upper limit distance of waving gestures of testers; and
(f) minimum swing distance of each basic gesture is denoted by minDistance; an amplitude of gesture swing which can be recognized by the method of the present invention shall not be less than the minimum swing distance whose value range is 0.10 m-0.20 m;

if one of the above conditions is not met, the value of curState remains “RANDOM”;

end and

(3) if curState==“LEFT”
when one of the following conditions is met, the left swing is interrupted:
(a) Y coordinates of two consecutive points increase;
(b) increase amplitudes of Z coordinates of two consecutive points are greater than decrease amplitudes of Y coordinates;
(c) decrease amplitudes of Z coordinates of two consecutive points are greater than decrease amplitudes of Y coordinates;
(d) defect points exceeds a preset maximum number or percentage, a value range of maximum number of defect points is 3-7 and a value range of maximum percentage of defect points is 20%-35%; and
(e) dx or dz exceeds a specified threshold which can be set as an average upper limit distance of waving gestures of testers.

If none of the above conditions are met, the value of curState remains “LEFT”.

end

The isGRight function, isGUp function and isGDown function follow the similar rules as the isGLeft function.

Step 4: if continuously determined basic gestures constitute a combined gesture, the combined gesture determination result can be output.

In order to save memory, upper limit of a length of a structure array saved by hand trajectory information collected by the millimeter wave radar is set to MAX_TRAJ_CNT. It can be adjusted manually. If too many points are collected, only information of latest MAX_TRAJ_CNT points should be saved. The gStartEndInner function caches a specified number of basic gestures and compares them with predefined combined gestures. In order to improve combined gesture recognition rate, two consecutive basic gestures with close time interval can be combined into one.

For a combined gesture, a self-defined variable combStepCnt is introduced to represent the number of basic gestures contained in the combined gesture. A self-defined structure array combStep is used to store continuous determined basic gestures. The combStep array length is combStepCnt and each member in the array contains information as follows:

(1) state, which represents a cached basic gesture; and
(2) elapsedMsec, which represents a maximum time interval of adjacent basic gestures and can be set according to specific application scenarios and requirements, if the time interval of adjacent basic gestures exceeding elapsedMsec, current combined gesture judgement is interrupted and a new combined gesture judgement needs to be restarted.

For example, drawing a rectangle clockwise can be defined as right swing, down swing, left swing and up swing. That is

combStepCnt=4;
combStep(1).state=“RIGHT”;
combStep(1).elapsedMsec=1000000;
combStep(2).state=“DOWN”;
combStep(2).elapsedMsec=1000000;
combStep(3).state=“LEFT”;
combStep(3).elapsedMsec=1000000;
combStep(4).state=“UP”;
combStep(4).elapsedMsec=1000000;

Drawing a rectangle counterclockwise can be defined as left swing, down swing, right swing and up swing. That is

combStepCnt=4;
combStep(1).state=“LEFT”;
combStep(1).elapsedMsec=1000000;
combStep(2).state=“DOWN”;
combStep(2).elapsedMsec=1000000;
combStep(3).state=“RIGHT”;
combStep(3).elapsedMsec=1000000;
combStep(4).state=“UP”;
combStep(4).elapsedMsec=1000000.

1. A millimeter wave radar gesture recognition method based on trajectory judgment comprising steps of:
Step 1: obtaining data information of each point of a human hand movement trajectory by a micro control unit according to echo signals;
Step 2: setting a retrieval method of a trajectory start point and an end point, which obeys rules of including all gestures while reducing repeated trajectory judgments;
Step 3: for a trajectory whose start point and end point are given, calculating slopes of least squares straight lines of coordinates and Z coordinates with respect to t coordinates which represent time respectively at first; precluding impossible basic gestures, then judging whether a current gesture is one of remaining basic gestures combining with a variation amplitude of each coordinate axis direction, wherein the basic gestures refer to left swing, right swing, up swing and down swing; and
Step 4: if continuously determined basic gestures constitute a combined gesture, outputting a combined gesture determination result.

2. The millimeter wave radar gesture recognition method, as recited in claim 1, wherein:
each point of the human hand movement trajectory as described in the Step 1 comprises information as follows: a frame number which is denoted by frame_num, a number of points collected by a millimeter wave radar in a current frame which is denoted by target_num, a current time value which is denoted by msec and a 3D coordinate of a currently collected point which is denoted by (x,y,z).

3. The millimeter wave radar gesture recognition method, as recited in claim 1, wherein:
the retrieval method of the start point and the end point of the trajectory as described in the Step 2 introduces a self-defined outer function gStartEndInner to update the start point and the end point of the trajectory for gesture judgments; the outer function gStartEndInner comprises operations as follows:
(1) denoting a current gesture state variable by curState whose initial value is set as “RANDOM”; denoting a minimum time interval by minGPartInterval; wherein an initial start point and an end point are set as a first point of millimeter wave radar data acquisition; when a time interval between the start point and the end point is less than minGPartInterval, the gesture of the trajectory is not judged; when a new point arrives, the end point moves back one point;
(2) when the time interval between the start point and the end point is greater than or equal to minGPartInterval, judging which basic gesture the trajectory belongs to; wherein results comprise left swing, right swing, up swing, down swing, and random; if a judgement result is the left swing, a value of curState is set as LEFT while keeping the start point unchanged; the end point is a last point collected in the current time until the left swing is interrupted; at this time, the start point and the end point of the left swing are output; both the new start point and the end point become the point of a last left swing end time; the above method is also applicable to the right swing, the up swing and the down swing; and
(3) if the value of the curState is RANDOM and the basic gesture is not determined after the maximum time interval maxGParfInterval; moving the start point for trajectory judgment forward one point while the end point remains unchanged; when the time interval between the start point and the end point is less than maxGPartInterval, the end point slides back one point and the start point becomes the end point of a previous base gesture.

4. The millimeter wave radar gesture recognition method, as recited in claim 3, wherein:
a value range of minGPartInterval is from 0.3 s-1 s and a value range of maxGparthInterval is from 1.5 s-1 s.

5. The millimeter wave radar gesture recognition method, as recited in claim 3, wherein:
in the outer function gStartEndInner, repeated judgements are reduced; every time a new point comes, the judgements of all trajectories ending at the last point of the current time is finished, which ensures that when the new point arrives, only the trajectories ending at the new point is judged.

6. The millimeter wave radar gesture recognition method, as recited in claim 3, wherein:
the step 3 comprises specific steps of:
introducing a self-defined inner function gStateTrans, wherein for a trajectory whose start point and end point are given, the inner function gives the gesture judgment result according to a value of curState at a previous time; specific operations of the inner function comprise steps of:
S301, for the trajectory whose start point and end point are given, calculating slopes of least squares straight lines of Y coordinates and Z coordinates YT and ZT with respect to t coordinates which represent time respectively at first wherein YT and ZT reflect an average velocity of the trajectory in Y-axis and Z-axis directions respectively;
S302, denoting a change amplitude of X coordinates on the trajectory by dx, wherein dx is calculated by subtracting a minimum value from a maximum value in remaining X coordinates after removing maximum and minimum X coordinates; dy and dz are calculated in the similar way;
S303, when the value of curState in current time is “RANDOM”:
(a) if |YT|>|ZT|, YT<0, only judging whether the current trajectory is the left swing;
(b) if |YT|>|ZT|, YT>0, only judging whether the current trajectory is the right swing;
(c) if |YT|<|ZT|, YT<0, only judging whether the current trajectory is the up swing; and
(d) if |YT|<|ZT|, YT>0, only judging whether the current trajectory is the down swing; and
S304, when the value of curState in current time is not “RANDOM”:
(a) if curState==“LEFT”, only judging whether the current left swing is interrupted;
(b) if curState==“RIGHT”, only judging whether the current right swing is interrupted;
(c) if curState==“UP”, only judging whether the current up swing is interrupted; and
(d) if curState==“DOWN”, only judging whether the current down swing is interrupted.

7. The millimeter wave radar gesture recognition method, as recited in claim 6, wherein:
in the S303, the value of curState in current time is “RANDOM”:
for the left swing, the Y coordinates conform to a decreasing trend; for two points collected at adjacent times on the trajectory, if the Y coordinate of current time is greater than the Y coordinate of previous time, the point of the current time is defined as a defect point; if |YT|>|ZT|, YT<0, when all conditions as follows are met, the value of curState is switched to “LEFT”: Condition a, a number of defect points is less than a preset maximum number while a percentage of the defect points is lower than a preset maximum percentage; a value range of maximum defect points is 3-7 and a value range of a maximum percentage of the defect points is 20%-35%; Condition b, Y coordinates of second and third points on the trajectory are less than the Y coordinate of the start point; Condition c, a number of points the trajectory contains at least is denoted by minNum whose value range is 3-7; Condition d, dy>dz; Condition e, both dx and dz do not exceed a specified threshold which is set as an average upper limit distance of waving gestures of testers; and Condition f, a minimum distance which is set for each basic gesture is denoted by minDistance; a gesture swing amplitude recognized is not less than minDistance whose value range is 0.10 m-0.20 m.

8. The millimeter wave radar gesture recognition method, as recited in claim 6, wherein:
in the S304, when the value of curState in current time is not “RANDOM”:
if curState=“LEFT”, when one of the following conditions is met, the left swing is interrupted: Condition a, Y coordinates of two consecutive points increase; Condition b, increase amplitudes of Z coordinates of two consecutive points are greater than decrease amplitudes of Y coordinates; Condition c, decrease amplitudes of Z coordinates of two consecutive points are greater than the decrease amplitudes of the Y coordinates; Condition d, a number of defect points exceeds a preset maximum number while a percentage of the defect points exceeds a preset maximum percentage; a value range of maximum defect points is 3-7 and a value range of a maximum percentage of the defect points is 20%-35%; and Condition e, dx or dz exceeds a specified threshold which is set as an average upper limit distance of waving gestures of testers;
when the left swing is interrupted, the start point of the current trajectory become the start point of the left swing; the end point becomes a point at the previous time of the interruption point; the value of curState switches to “RANDOM”.

9. The millimeter wave radar gesture recognition method, as recited in claim 1, wherein:
the combined gestures are predefined in the Step 4 while a structure array is defined to cache the judgment results of successive basic gestures; when there are four successive basic gestures of the right swing, the down swing, the left swing and the up swing, a predefined combined gesture is determined; on the other hand, in a judgement process of the combined gestures, two consecutive same basic gestures are combined into one in order to improve a combined gesture recognition rate.

10. A millimeter wave radar gesture recognition device based on trajectory judgment, comprising:
a millimeter wave RF (Radio Frequency) transceiver unit, a micro control unit, a transmitting antenna and a receiving antenna;
wherein the micro control unit is connected to the millimeter wave RF transceiver unit; the millimeter wave RF transceiver unit is connected to the transmitting antenna and the receiving antenna respectively; the millimeter wave RF transceiver unit generates corresponding millimeter wave radar signals according to radar waveform parameters, receives echo signals reflected by the millimeter wave radar signals from human hands, and then transmits the echo signals to the micro control unit; the micro control unit outputs judgment results of personnel gestures by processing the echo signals; the transmitting antenna transmits the millimeter wave radar signals generated by the millimeter wave RF transceiver unit the receiving antenna receives millimeter wave radar signals reflected from space and transmits the millimeter wave radar signals reflected from space to the millimeter wave RF transceiver unit.
